(19) United States
(12) Patent Application Publication
(10) Pub. No.: US 2019/0002239 A1
(43) Pub. Date: Jan. 3, 2019

(54) METHOD FOR MONITORING A SAFETY CIRCUIT OF AN ELEVATOR SYSTEM AND MONITORING DEVICE FOR A SAFETY CIRCUIT OF AN ELEVATOR SYSTEM

(71) Applicant: Inventio AG, Hergiswil (CH)

(72) Inventor: Philipp Zimmerli, Härkingen (CH)

(73) Assignee: Inventio AG, Hergiswil (CH)

(21) Appl. No.: 15/781,729

(22) PCT Filed: Dec. 16, 2016
(86) PCT No.: PCT/EP2016/081333

§ 371 Date: Jun. 6, 2018

(30) Foreign Application Priority Data
Dec. 17, 2015 (EP) 15200893.4

(51) Int. Cl. B66B 5/00; B66B 13/22

(52) U.S. Cl. CPC B66B 5/0031; B66B 13/22; B66B 5/0025

(57) ABSTRACT

A method for monitoring a safety circuit and a monitoring device for a safety circuit of an elevator system are based on a monitoring device for a supply voltage of a series connection of switches for monitoring the safety of devices serving the elevator operation. Safety relays are connected to the end of the series connection, which relays generate signals for an elevator controller according to the switching state of the switches. The supply voltage is set such that the voltage is constant across the relays. Since there is an upper limit value to the supply voltage available from the voltage source, the supply voltage is monitored and an error notification is generated when an upper limit value is reached. In order to permit high levels of availability of the elevator system, at least one further parameter of a curve of the supply voltage is determined and evaluated.

### FIELD

The invention relates to a method for monitoring a safety circuit of an elevator system and a monitoring device for a safety circuit of an elevator system.

### BACKGROUND

EP 1 090 870 B1 describes a method for monitoring a safety circuit, and a monitoring device for a safety circuit of an elevator system. The monitored safety circuit comprises a series connection of switches for monitoring the safety of devices serving the elevator operation, and a voltage source for supplying the series connection with a supply voltage. A switch device in the form of a safety relay is connected to the end of the series connection, which safety relay generates signals for an elevator controller according to the switching state of the switches. If all the contacts of the safety circuit are closed, the safety relay is activated. The elevator controller monitors the state of the safety relay, and if the safety relay is activated, the elevator controller emits a pending car call command, for example. The supply voltage is set in such a way that the voltage is constant across the safety relay, so that a safety relay which has a small voltage range can be used. Since there is an upper limit value to the supply voltage that can be made available from the voltage source, the supply voltage is monitored and an error notification is generated when an upper limit value, for example 55 V, is reached. When the aforementioned error notification is generated, the voltage source is switched off, and the elevator system is put out of operation as a result.

### SUMMARY

In contrast, the aim of the invention is in particular to suggest an enhanced method for monitoring a safety circuit of an elevator system, and a monitoring device for a safety circuit of an elevator system, which device permits high levels of availability of the elevator system.

In the method according to the invention for monitoring a safety circuit of an elevator system, a supply voltage of the safety circuit is continuously monitored to check whether said voltage exceeds an upper limit value of 55 V, for example. The monitored safety circuit comprises a series connection of switches for monitoring the safety of devices serving the elevator operation, and a voltage source for supplying the series connection with the aforementioned supply voltage. A switch device in the form of a safety relay, for example, is connected to the end of the series connection, which safety relay generates at least one signal for an elevator controller according to the switching state of the switch. The supply voltage is set in such a way that the voltage is constant across the switch device. The voltage is set in particular by regulating the voltage across the switch device, using the supply voltage as the manipulated variable. According to the invention, at least one further parameter of a curve of the supply voltage is determined and evaluated.

The voltage drop over the series connection of the switches is a measure for the total resistance of the series connection. The total resistance is equal to the sum of the individual resistances of the switches connected in series. The resistance of a switch, for example an elevator door switch by means of which it can be verified whether a shaft door or elevator car door is closed, can increase if the switch becomes dirty or if the contacts corrode over time. The aforementioned total resistance can therefore provide an indication that at least one of the switches connected in series might fail in the near future. Moreover, the level of the supply voltage has an upper limit value, so the extent to which an increasing total resistance can be compensated for by increasing the supply voltage is limited. If the supply voltage reaches the aforementioned upper limit value, the supply voltage is in particular switched off, and the elevator system is thus deactivated.

When the voltage is constant across the switch device, i.e. at the end of the series connection of the switches, the aformentioned supply voltage is directly a measure of the total resistance of the series connection. By determining and evaluating, according to the invention, at least one further parameter of the curve of the supply voltage, an impending shutdown of the elevator system can be detected before the upper limit value is reached, and counter-measures can be implemented in a timely manner. As the supply voltage for the proper operation of the elevator system is set, it can be determined both easily and inexpensively. The aforementioned method can therefore likewise be carried out both easily and inexpensively.

According to an embodiment of the invention, it is determined, as a further parameter, whether the supply voltage exceeds a first limit value, the first limit value being lower than the upper limit value. The first limit value can be for example between 30 V and 50 V, in particular 40 V. In this way, a counter-measure can be implemented before the upper limit value is reached and the elevator system is deactivated.

According to an embodiment of the invention, it is determined, as a further parameter, whether the supply voltage exceeds a second limit value which is higher than the first limit value and lower than the upper limit value. The second limit value can be for example between 45 V and 50 V, in particular 50 V. By simply checking whether a second limit value, in addition to the first limit value, has also been exceeded, exceeding the first limit value can be considered a first warning, and exceeding a second limit value can be considered a second, more serious or important warning.

In addition to the first and second limit values, further limit values can also be monitored.

According to an embodiment of the invention, the first and/or the second limit value is established according to a starting value of the supply voltage. The limit values can thus be adjusted particularly well to the actual circumstances of the elevator system. The first limit value can be 10 V, for example, and the second limit value can be 20 V higher than the starting value of the supply voltage, for example.

According to an embodiment of the invention, the aforementioned starting value corresponds to a supply voltage after the first time the elevator system is operated or after maintenance has been carried out on the elevator system. After the first time the elevator system is operated or after maintenance has been carried out on the elevator system, it can be assumed that all the switches of the safety circuit have been checked and found to be in order. The supply voltage which is subsequently set is therefore a good and reliable reference or starting point. If the supply voltage, and thereby the total resistance of the switches in the safety circuit, increases significantly with respect to said starting value, it can be assumed that a problem with one or more of the switches is highly likely.

According to an embodiment of the invention, it is determined, as a third parameter, whether a change in the supply voltage exceeds a first change limit value within a first time period. In this way, a gradient, as it were, of the supply voltage is monitored. The aforementioned first time period can be, for example, one hour, one day, one week or one month. In the case of a short time period, for example of one hour or one week, a short term change in particular in the resistance of a switch can be detected and quickly reacted to. The change can be caused by dirt or moisture suddenly entering a switch, for example. In the case of a long time period, longer-term changes in the total resistance, caused for example by gradually progressing corrosion of contacts, can be detected.

According to an embodiment of the invention, it is determined, as a further parameter, whether a change in the supply voltage exceeds a second change limit value within a second time period. In this way, both short-term and longer-term changes can advantageously be monitored simultaneously, for example.

Further time periods having corresponding change limit values can also be monitored.

According to an embodiment of the invention, in order to evaluate the at least one further parameter, an entry is made in a readable memory, in particular an error memory or an error circuit. The memory can then be read out during maintenance, for example. Maintenance can be carried out by a maintenance technician on-site, for example. However, it is also possible for maintenance to be carried out as so-called remote maintenance, in which the error memory can be accessed remotely by means of a specified interface, for example by means of a data line. Data on whether, and optionally when, the supply voltage or the temporal curve thereof exceed which limit value, is in particular entered into the memory. In this way, it can be easily and inexpensively checked during maintenance whether the switches and the safety devices need to be examined in more detail.

According to an embodiment of the invention, maintenance of the elevator system is carried out in order to evaluate the at least one further parameter. The requirement of maintenance can be carried out by means of an interface to a central maintenance center, by means of a data line, for example. If the supply voltage exceeds the first limit value, an entry can be made in the memory, for example. In this case, the level of the supply voltage may be considered slightly high, but not yet be considered highly critical. A review during the next maintenance is therefore considered sufficient. If the supply voltage subsequently also exceeds the second limit value, it is highly probable that, without counter-measures, said voltage will also reach the upper limit value in the near future, resulting in the elevator system being deactivated. To be certain of avoiding this, maintenance of the elevator system is requested when the second limit value is reached. In this way, particularly high levels of availability of the elevator system are achieved. In particular, the reason for the maintenance, i.e. the fact that the second limit value was exceeded by the supply voltage in the example described, can also be transmitted with the maintenance request.

The aforementioned aim is also achieved by a monitoring device for a safety circuit of an elevator system, the safety circuit comprising a series connection of switches for monitoring the safety of devices serving the elevator operation, and a voltage source for supplying the series connection with a supply voltage, and at least one switch device being connected to the end of the series connection, which switch device generates at least one signal for an elevator controller according to the switching state of the switches. The supply voltage is set in such a way that the voltage is constant across the switch device. The monitoring device is provided for monitoring whether the supply voltage exceeds an upper limit value. According to the invention, the monitoring device is also provided for defining and evaluating at least one further parameter of a curve of the supply voltage.

Further advantages, features and details of the invention are set out in the following description of embodiments and in the drawings, in which identical or functionally identical elements are denoted with the same reference signs.

### DESCRIPTION OF THE DRAWINGS

In the drawings:

FIG. 1 is a schematic view of a safety circuit having a regulated voltage across a switch device,

FIG. 2 is a detail of one of the networks which regulates the voltage, and

FIG. 3 shows an example of a curve of a supply voltage of the safety circuit over time.

### DETAILED DESCRIPTION

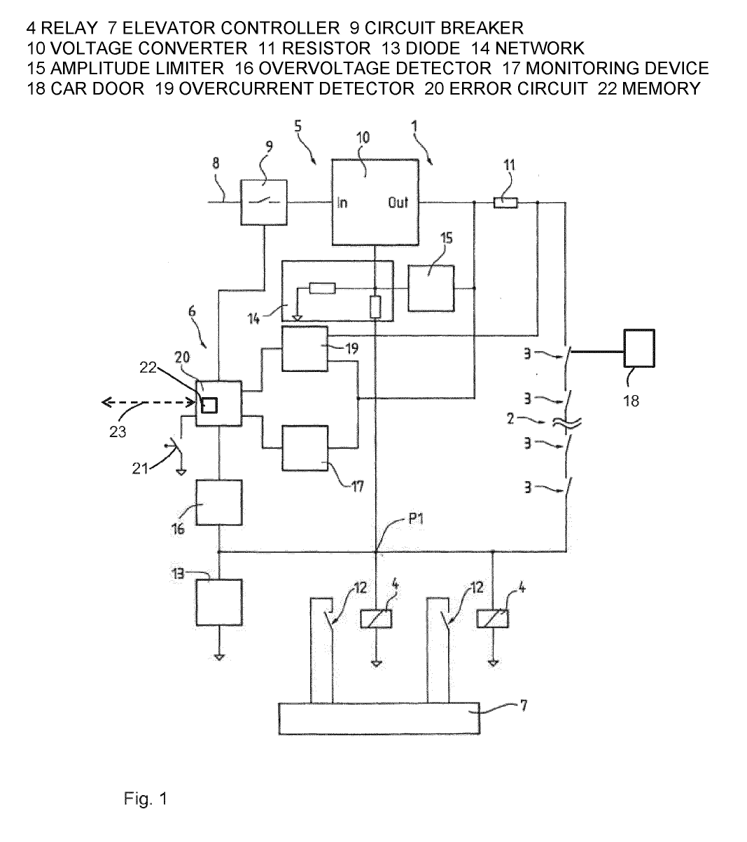

In FIG. 1, a safety circuit is denoted by the reference sign 1, which circuit consists of a series connection 2 of switches and contacts 3, at least one switch device in the form of a safety relay 4, a voltage source, which acts as a supply 5, in the form of a voltage converter 10, and a monitoring device 6, the signal of the safety relay 4 being supplied for an elevator controller 7. The switches 3 are used for monitoring the safety of devices serving the elevator operation. For example, switch 3 is designed as a so-called door contact switch, which is closed when a corresponding elevator car door 18 is closed.

A voltage of 24 V DC (direct current voltage), for example, is applied to an input line 8, which voltage is supplied to a circuit breaker 9. The circuit breaker 9 is externally connected to the input “In” of the DC-DC voltage converter 10 which raises the 24 V to 25 V to 50 V, for example. The output voltage of the DC-DC voltage converter 10 is used as the supply voltage of the series connection 2 of switches 3. One end of the series connection 2 of contacts 3 is connected to the output “Out” of the voltage converter 10 by a precision resistor 11, and the other end of the series connection 2 is connected to the safety relays 4. The second connection of each safety relay 4 is connected to a common conductor, symbolized by a downward-pointing arrow. The switching state of the safety relay 4 is conveyed to a relay contact 12, by means of which the elevator controller 7 guides a signal voltage. In order to protect the safety circuit 1 from voltage peaks caused by switching inductors, a protective diode 13, for example, is connected across the safety relays 4.

The voltage to be regulated across the safety relay 4 is tapped at the point P1 and supplied to a network 14, which consists of passive elements and is connected to the voltage converter 10. If all the contacts 3 of the series connection 2 are closed, the voltage is kept constant at 25 V DC, for example, across the safety relay 4. If the series connection 2 is open, the output voltage of the voltage converter 10 is kept at 53 V, for example, by means of an amplitude limiter 15.

The monitoring unit 6 consists of an overvoltage detector 16, a monitoring device 17 of the supply voltage and an overcurrent detector 19. The overvoltage detector 16 monitors the voltage across the safety relay 4 and generates an error notification if the monitored voltage exceeds 28 V DC, for example. The monitoring device 17 of the supply voltage is explained in more detail below. The overcurrent detector 19 monitors the current flowing in the series connection 2 in the form of a voltage by means of the precision resistor 11, and generates an error notification if the monitored current exceeds 300 mA, for example. The error notifications of the detectors 16, 19 and of the monitoring device 17 are supplied to an error circuit 20 which opens the circuit breaker 9 when particular error notifications are generated, which circuit breaker switches off the voltage at the input “In” of the DC-DC voltage converter 10. The error circuit 20 stores the errors which have occurred in a readable memory 22, it being possible for said errors to be read out from a maintenance center, as described, by means of a data line 23. A button 21 is provided for manually resetting the error circuit 20. It is also possible for the error circuit 20 to be reset from the maintenance center by means of the data line 23. Maintenance of the elevator system can also be carried out from the maintenance center by means of the data line 23.

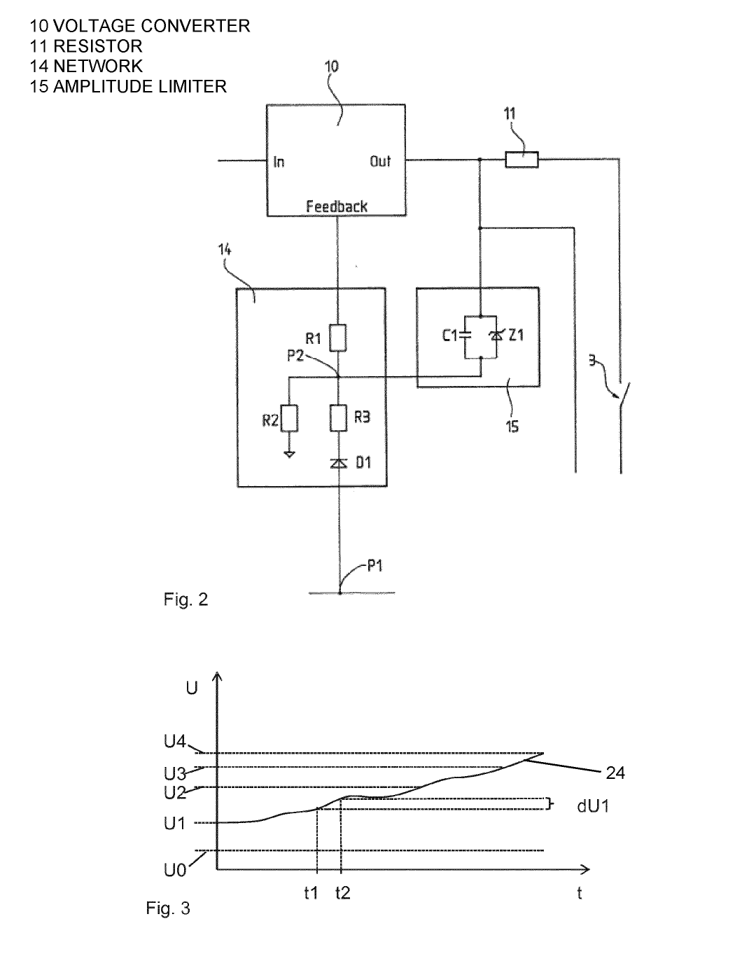

FIG. 2 shows details of the network 14 and of the amplitude limiter 15 for regulating voltage across the safety relay 4. If the series connection 2 is open, the output voltage of the voltage converter 10 is kept constant at 53 V DC, for example, by a Zener diode Z1. A capacitator C1 increases the dynamic behavior of the amplitude limiter 15.

If all the contacts 3 of the series connection 2 are closed, the voltage at the point P1 is kept constant at 25 V DC, for example, across the safety relay 4. The voltage at the point P1 is supplied to a voltage divider, which consists of resistor R3 and resistor R2, by a diode D1, which inhibits reverse current, the voltage dividing point P2 being connected to the amplitude limiter 15 and to a limiting resistor R1, which is connected, on the other side thereof, to the input “Feedback” of the voltage converter 10. The voltage converter 10 regulates the voltage at the output “Out” based on the signal at the input “Feedback”. Voltage converter 10, series connection 2 and network 14 form a closed control loop which keeps the voltage at the point P1 constant. Deviating voltages are detected by the detector 16 and the monitoring device 17.

The functioning of the monitoring device 17 of the supply voltage is explained in more detail with reference to FIG. 3. In FIG. 3, a line 24 shows the temporal curve, over several months, of the supply voltage of the series connection 2. The curve of the supply voltage is only an example, and is shown in a very simplified manner.

The monitoring device 17 monitors the supply voltage, i.e. the voltage at the output “Out” of the voltage converter 10, and generates a first error notification if the supply voltage falls below a lower limit value U0 of 23 V, for example. Said device also monitors whether the supply voltage exceeds a first limit value U2, a second limit value U3 and an upper limit value U4, and generates a second error notification (U2 exceeded), a third error notification (U3 exceeded) and a fourth error notification (U4 exceeded) when said limit values are exceeded.

The first and second limit values U2, U3 are established according to a starting value U1 of the supply voltage, which corresponds to a supply voltage the first time the elevator system is operated or at the most recent maintenance of the elevator system. In this case, the two limit values U2, U3 are each greater than the starting value U1 by a specified amount. However, it is also possible for the two limit values to be determined independently of a starting value.

Furthermore, the monitoring device 17 also checks whether a change dU1 in the supply voltage exceeds a first change limit value within a first time period (t1-t2), and, moreover, whether the change in the supply voltage exceeds a second change limit value within a second time period. When the first change limit value is exceeded, a fifth error notification is generated, and when the second change limit value is exceeded, a sixth error notification is generated.

The monitoring device 17 transmits the aforementioned error notification to the error circuit 20, which reacts differently depending on the type of error notification. When a first error notification (voltage below U0) or a fourth error notification (U4 exceeded) is transmitted, the error circuit 20 opens the circuit breaker 9, which switches off the voltage at the input “In” of the DC-DC voltage converter 10. When a second error notification (U2 exceeded) and a fifth error message (first change limit value exceeded) are transmitted, the error notification is merely stored in the memory 22, and can be read out the next time maintenance is carried out on the elevator system. When a third error notification (U3 exceeded) and a sixth error notification (second change limit value exceeded) are transmitted, maintenance is requested by means of the data line 23.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A method for monitoring a safety circuit of an elevator system, the safety circuit having a series connection of switches for monitoring the safety of devices serving the elevator operation, and a voltage source for supplying the series connection with a supply voltage, and at least one switch device being connected to an end of the series connection, which device generates at least one signal for an elevator controller according to the switching state of the switches, the method comprising the steps of:
setting the supply voltage to maintain a constant voltage across the switch device;
monitoring whether the supply voltage exceeds an upper limit value; and
determining and evaluating at least one parameter of a curve of the supply voltage over time.

12. The method according to claim 11 wherein the at least one parameter is whether the supply voltage exceeds a first limit value.

13. The method according to claim 12 including determining and evaluating a further parameter being whether the supply voltage exceeds a second limit value that is greater than the first limit value.

14. The method according to claim 13 including establishing at least one of the first limit value and the second limit value according to a starting value of the supply voltage.

15. The method according to claim 14 wherein the starting value corresponds to a supply voltage after a first time the elevator system is operated or after maintenance has been carried out on the elevator system.

16. The method according to claim 11 wherein the at least one parameter is whether a change in the supply voltage exceeds a first change limit value within a first time period.

17. The method according to claim 16 including determining and evaluating whether the change in the supply voltage exceeds a second change limit value within a second time period.

18. The method according to claim 11 wherein, in order to evaluate the at least one parameter, an entry associated with the at least one parameter is made in a readable memory.

19. The method according to claim 11 wherein, in order to evaluate the at least one parameter, maintenance of the elevator system is requested.

20. A monitoring device for a safety circuit of an elevator system, the safety circuit including a series connection of switches for monitoring the safety of devices serving the elevator operation, and a voltage source for supplying the series connection with a supply voltage, and at least one switch device being connected to an end of the series connection, which device generates at least one signal for an elevator controller according to a switching state of the switches, the supply voltage being set to maintain a constant voltage across the switch device, the monitoring device comprising:
means to monitor a parameter of whether the supply voltage exceeds an upper limit value; and
means for determining and monitoring at least another parameter of a curve of the supply voltage over time.
